(19) United States
(12) Patent Application Publication
(10) Pub. No.: US 2023/0420646 A1
(43) Pub. Date: Dec. 28, 2023

(54) MULTI-FUNCTIONAL SUPPORTED ANODE AND CATHODES

(71) Applicant: FORD GLOBAL TECHNOLOGIES, LLC, Dearborn, MI (US)

(72) Inventors: Eunsung LEE, Novi, MI (US); Feng LI, Troy, MI (US); Chi PAIK, Grosse Ile, MI (US)

(21) Appl. No.: 17/851,298

(22) Filed: Jun. 28, 2022

(51) Int. Cl. H01M 4/36; H01M 4/134; H01M 4/505; H01M 10/0525; H01M 4/131

(52) U.S. Cl. CPC H01M 4/364; H01M 4/134; H01M 4/505; H01M 10/0525; H01M 4/131; H01M 2004/028

(57) ABSTRACT

A hybrid positive electrode active material includes a first positive electrode active powder and a second positive electrode active powder. Each particle of the second positive electrode active powder contacts a plurality of particles of the first positive electrode active material. Characteristically, the average particle size of the first positive electrode active powder is smaller than the average particle size of the second positive electrode active powder.

### TECHNICAL FIELD

In at least one aspect, a hybrid electrode including a hybrid active material is provided.

### BACKGROUND

Cathode active materials offer specific functions to enable desirable cell performances. These functions are typically specified with different cathode types and involve different tradeoffs or solutions. Such tradeoffs include high energy, high energy or high power, or high performance or long life. Multi-functional cathodes are highly sought for especially demanding automotive usages such as high energy and high power, or high performance. In each case, long battery life is a desirable attribute that can provide a competitive edge.

Accordingly, there is a need for alternative battery electrode designs and in particular, for alternative positive electrode designs.

### SUMMARY

In at least one aspect, a hybrid positive electrode material is provided. The hybrid positive electrode material includes a first positive electrode active powder and a second positive electrode active powder. Each particle of the second positive electrode active powder contacts a plurality of particles of the first positive electrode active material. Characteristically, the average particle size of the first positive electrode active powder is smaller than the average particle size of the second positive electrode active powder.

In another aspect, a positive electrode for a rechargeable lithium-ion battery is provided. The positive electrode includes a current collector and an electrochemically active layer disposed over the current collector. The electrochemically active layer includes a hybrid positive electrode active material having a first positive electrode active powder; and a second positive electrode active powder. Each particle of the second positive electrode active powder contacts a plurality of particles of the first positive electrode active powder. Advantageously, the average particle size of the first positive electrode active powder is smaller than the average particle size of the second positive electrode active powder.

In another aspect, a rechargeable lithium-ion battery is provided. The rechargeable lithium-ion battery includes at least one lithium-ion battery cell. Each lithium-ion battery cell includes a positive electrode that includes a current collector and an electrochemically active layer disposed over the current collector. The electrochemically active layer comprising a hybrid positive electrode active material includes a first positive electrode active powder and a second positive electrode active powder. Each particle of the second positive electrode active powder contacts a plurality of particles of the first positive electrode active powder. Advantageously, the average particle size of the first positive electrode active powder is smaller than the average particle size of the second positive electrode active powder. The rechargeable lithium-ion battery also includes a negative electrode including a negative active material and an electrolyte contacting the positive electrode and the negative electrode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A. Schematic cross-section of a positive electrode including a hybrid positive electrode active material and coated on one side of a current collector.

FIG. 1B. Schematic cross-section of a positive electrode including a hybrid positive electrode active material and coated on both sides of a current collector.

FIG. 2A. Schematic cross-section of a supported hybrid positive electrode active material.

FIG. 2B. Schematic cross-section of an intermixed hybrid positive electrode active material.

FIG. 2C. Schematic cross-section of a core-shell hybrid positive electrode active material.

FIG. 3A. Schematic cross-section of a negative electrode including a hybrid negative electrode active material and coated on one side of a current collector.

FIG. 3B. Schematic cross-section of a negative electrode including a hybrid negative electrode active material and coated on both sides of a current collector.

FIG. 3C. Schematic showing larger particles such as LaLiTiO₃ supporting smaller LTO or graphite particles.

FIG. 4. Schematic cross-section of a battery cell incorporating the electrode of FIG. 2A.

FIG. 5. Schematic cross-section of a battery incorporating the battery cell of FIG. 3.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, amounts, temperature, and reaction conditions (e.g., pressure, pH, flow rates, etc.) can be practiced with plus or minus 50 percent of the values indicated rounded to or truncated to two significant figures of the value provided in the examples. In a refinement, amounts, temperature, and reaction conditions (e.g., pressure, pH, flow rates, etc.) can be practiced with plus or minus 30 percent of the values indicated rounded to or truncated to two significant figures of the value provided in the examples. In another refinement, amounts, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

### Abbreviations

“LCO” means lithium cobalt oxide.

“NCMA” means nickel cobalt manganese aluminum quaternary material.

“NCA” means nickel cobalt aluminum ternary material.

“LFP” means lithium iron phosphate.

“LMP” means lithium manganese phosphate.

“LVP” means lithium vanadium phosphate.

“LMO” means lithium manganate.

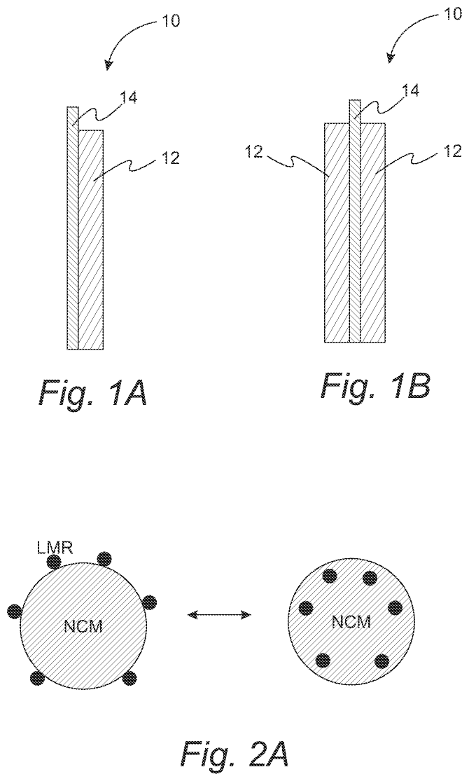

Referring to FIGS. 1A and 1B, schematics of a positive electrode that includes a mixed positive electrode active material are provided. Positive electrode 10 includes a mixed positive electrode active material layer 12 including a hybrid positive electrode active material disposed over and typically contacting positive electrode current collector 14. Typically, positive electrode current collector 14 is a metal plate or metal foil composed of a metal such as aluminum, copper, platinum, zinc, titanium, and the like. Currently, copper is most commonly used for the positive electrode current collector. The hybrid positive electrode material includes a first positive electrode active powder and a second positive electrode active powder. Each particle of the second positive electrode active powder contacts a plurality of particles of the first positive electrode active powder. Advantageously, an average particle size of the first positive electrode active powder is smaller than an average particle size of the second positive electrode active powder. FIG. 1A shows an example with the hybrid positive electrode active material layer 12 disposed over a single face of the current collector 14 while FIG. 1B shows an example with the hybrid positive electrode active material layer 12 disposed over two opposite faces of the current collector 14.

In a variation, the average particle size of the first positive electrode active powder from about 10 nm to about 1 micron and the average particle size of the second positive electrode active powder has an average particle size from about 1 to 20 microns.

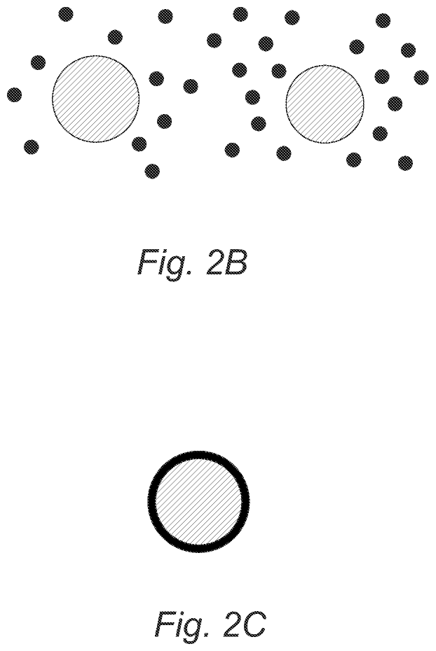

In a variation, each particle of the second positive electrode active powder supports the plurality of particles of the first positive electrode active powder as depicted in FIG. 2A. Advantageously, each particle of the second positive electrode active powder has a sufficient pore size to allow the particles of the first positive electrode active powder to embed therein upon swelling of the particles in the second positive electrode active powder. Such swelling can occur when the positive electrode is stressed such as becoming hot during charging or discharging. FIG. 2 illustrates LMR particle embedding in NCM under stress conditions.

In another variation, the first positive electrode active powder is intermixed with the second positive electrode active powder as depicted in FIG. 2B.

In still another variation, a shell composed of the first positive electrode active powder is disposed over a core composed of the second positive electrode active powder FIG. 2C.

In some variations, the first positive electrode active powder is composed of a high power lithium de-intercalating/intercalating active material while the second positive electrode active powder is composed of a high energy active material. For example, the first positive electrode active powder is composed of a component selected from the group consisting of lithium manganate, doped lithium manganate, or nickel cobalt manganese and/or the second positive electrode active powder is composed of an electrochemically active material including nickel in an amount greater than 60 weight percent of the total weight of the second positive electrode active powder. In a refinement, the second positive electrode active powder includes a component selected from the group consisting of nickel cobalt manganese ternary material (NCM), nickel cobalt aluminum ternary material (NCA), nickel cobalt manganese aluminum quaternary material (NCMA), and combinations thereof.

In still another variation, the second positive electrode active powder is composed of a perovskite material and the first positive electrode active powder is composed of a high power lithium manganate or and electrochemically active material including nickel in an amount greater than 60 weight percent of the total weight of the second positive electrode active powder.

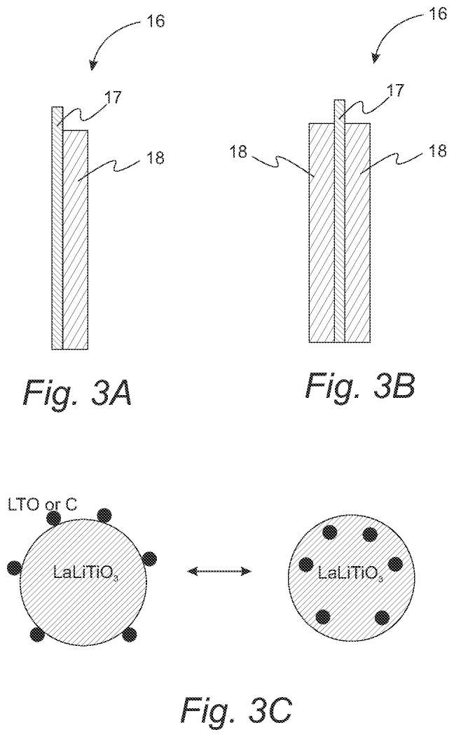

Referring to FIGS. 3A and 3B, schematics of a negative electrode that includes a mixed negative electrode active material are provided. Negative electrode 10 includes a mixed negative electrode active material layer 12 including a hybrid negative electrode active material disposed over and typically contacting negative electrode current collector 17. Typically, negative electrode current collector 17 is a metal plate or metal foil composed of a metal such as aluminum, copper, platinum, zinc, titanium, and the like. Currently, aluminum is most commonly used for the negative electrode current collector. The hybrid negative electrode material includes a first negative electrode active powder and a second negative electrode active powder. Each particle of the second negative electrode active powder contacts a plurality of particles of the first negative electrode active powder. Advantageously, the average particle size of the first negative electrode active powder is smaller than the average particle size of the second negative electrode active powder. FIG. 3A shows an example with the hybrid negative electrode active material layer 12 disposed over a single face of the current collector 14 while FIG. 3B shows an example with the hybrid negative electrode active material layer 12 disposed over two opposite faces of the current collector 17. The hybrid negative material can be a supported structure, intermixed, or core shell as described above for the positive electrode material.

FIG. 3C show a larger particles such as LaLiTiO₃ supporting smaller LTO or graphite particles which can embed in the larger particle under stress conditions as described above.

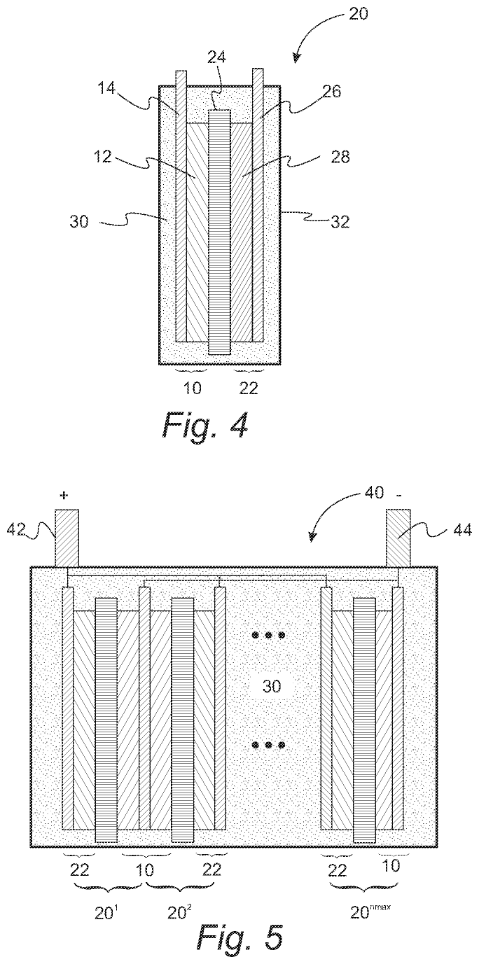

With reference to FIG. 4, a schematic of a rechargeable lithium-ion battery cell incorporating the positive electrode of FIG. 1 is provided. Battery cell 20 includes positive electrode 10 as described above, negative electrode 22, and separator 24 interposed between the positive electrode and the negative electrode. Negative electrode 22 includes a negative electrode current collector 26 and a negative active material layer 28 disposed over and typically contacting the negative current collector. Typically, negative electrode current collector 26 is a metal plate or metal foil composed of a metal such as aluminum, copper, platinum, zinc, titanium, and the like. Currently, copper is most commonly used for the negative electrode current collector. The battery cell is immersed in electrolyte 30 which is enclosed by battery cell case 32. Electrolyte 30 imbibes into separator 24. In other words, the separator 24 includes the electrolyte thereby allowing lithium ions to move between the negative and positive electrodes. The electrolyte includes a non-aqueous organic solvent and lithium salt. The non-aqueous organic solvent serves as a medium for transmitting ions taking part in the electrochemical reaction of a battery.

With reference to FIG. 5, a schematic of a rechargeable lithium-ion battery incorporating the positive electrodes of FIGS. 1A and 1B and the battery cells of FIG. 3 is provided. Rechargeable lithium-ion battery 40 includes at least one battery cell of the design in FIG. 2. Typically, rechargeable lithium-ion battery 40 includes at least one battery cell 20ⁱ of the design of FIG. 3. Each battery cell 20ⁱ includes a positive electrode 10 as described above, a negative electrode 22 which includes a negative active material, and an electrolyte 30, where i is an integer label for each battery cell. The label i runs from 1 to nmax, where nmax is the total number of battery cells in rechargeable lithium-ion battery 40. The electrolyte 30 includes a non-aqueous organic solvent and a lithium salt. The non-aqueous organic solvent serves as a medium for transmitting ions taking part in the electrochemical reaction of a battery. The plurality of battery cells can be wired in series, in parallel, or a combination thereof. The voltage output from battery 40 is provided across terminals 42 and 44. In another variation, the positive electrode and/or the negative electrode each independently include at least one layer of perovskite-supported material. In another variation, the positive electrode and/or the negative electrode each independently include at least one layer of perovskite-supported material.

In another variation, the positive electrode active material includes an active material of the perovskite structure (e.g., CaTiO₃ and similar ABX₃ structure) contact (e.g., host, support, etc.) a different cathode particle with a different function.

In another variation, the negative active material includes an active material of the perovskite structure (e.g., ABX₃ structure) contact (e.g., host, support, etc.) a different anode particle with a different function.

Referring to FIGS. 4 and 5, separator 24 physically separates the negative electrode 22 from the positive electrode 10 thereby preventing shorting while allowing the transport of lithium ions for charging and discharging. Therefore, separator 24 can be composed of any material suitable for this purpose. Examples of suitable materials from which separator 24 can be composed include but are not limited to, polytetrafluoroethylene (e.g., TEFLON®), glass fiber, polyester, polyethylene, polypropylene, and combinations thereof. Separator 24 can be in the form of either a woven or non woven fabric. Separator 24 can be in the form of a non-woven fabric or a woven fabric. For example, a polyolefin-based polymer separator such as polyethylene and/or polypropylene is typically used for a lithium-ion battery. In order to ensure heat resistance or mechanical strength, a coated separator includes a coating of ceramic or a polymer material may be used.

Referring to FIGS. 4 and 5, electrolyte 30 includes a lithium salt dissolved in the non-aqueous organic solvent. Therefore, electrolyte 30 includes lithium ions that can intercalate into the positive electrode active material during charging and into the anode active material during discharging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O₄)₂, and combinations thereof. In a refinement, the electrolyte includes the lithium salt in an amount from about 0.1 M to about 2.0 M.

Still referring to FIGS. 4 and 5, the electrolyte includes a non-aqueous organic solvent and a lithium salt. Advantageously, the non-aqueous organic solvent serves as a medium for transmitting ions, and in particular, lithium ions can participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvent include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent can be used singularly. In other variations, mixtures of the non-aqueous organic solvent can be used. Such mixtures are typically formulated to optimize battery performance. In a refinement, a carbonate-based solvent is prepared by mixing a cyclic carbonate and a linear carbonate. In a variation, electrolyte 30 can further include vinylene carbonate or an ethylene carbonate-based compound to increase battery cycle life.

Referring to FIGS. 1, 4, and 5, the negative electrode and the positive electrode can be fabricated by methods known to those skilled in the art of lithium-ion batteries. Typically, an active material (e.g., the mixed positive electrode or negative electrode active material) is mixed with a conductive material, and a binder in a solvent (e.g., N-methylpyrrolidone) into an active material composition and coating the composition on a current collector. The electrode manufacturing method is well known and thus is not described in detail in the present specification. The solvent includes N-methylpyrrolidone and the like but is not limited thereto.

Referring to FIGS. 1, 4, and 5, the positive electrode active material layer 12 includes the mixed positive electrode active material described above includes a binder, and a conductive material. The binder can increase the binding properties of positive electrode active material particles with one another and with the positive electrode current collector 14. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 4, and 5, the negative active material layer 26 includes a negative active material, includes a binder, and optionally a conductive material. The negative active materials used herein can be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 1.1. Mixtures of carbon-based negative active materials, silicon-based negative active materials can also be used for the negative active material.

The negative electrode binder increases the binding properties of negative active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A hybrid positive electrode material comprising:
a first positive electrode active powder; and
a second positive electrode active powder, each particle of the second positive electrode active powder contacting a plurality of particles of the first positive electrode active powder, wherein an average particle size of the first positive electrode active powder is smaller than an average particle size of the second positive electrode active powder.

2. The hybrid positive electrode material of claim 1, wherein the average particle size of the first positive electrode active powder is from about 10 nm to about 1 micron and the average particle size of the second positive electrode active powder has an average particle size from about 1 to 20 microns.

3. The hybrid positive electrode material of claim 1, wherein each particle of the second positive electrode active powder supports the plurality of particles of the first positive electrode active powder.

4. The hybrid positive electrode material of claim 3, wherein each particle of the second positive electrode active powder has a sufficient pore size to allow the particles of the first positive electrode active powder to embed therein upon swelling of the particles in the second positive electrode active powder.

5. The hybrid positive electrode material of claim 1, wherein the first positive electrode active powder is intermixed with the second positive electrode active powder.

6. The hybrid positive electrode material of claim 1, wherein a shell composed of the first positive electrode active powder is disposed over a core composed of the second positive electrode active powder.

7. The hybrid positive electrode material of claim 1, wherein the first positive electrode active powder is composed of a high power lithium de-intercalating/intercalating active material while the second positive electrode active powder is composed of a high energy active material.

8. The hybrid positive electrode material of claim 1, wherein the first positive electrode active powder is composed of a component selected from the group consisting of lithium manganate, doped lithium manganate, or nickel cobalt manganese.

9. The hybrid positive electrode material of claim 1, wherein the second positive electrode active powder is composed of an electrochemically active material including nickel in an amount greater than 60 weight percent of the total weight of the second positive electrode active powder.

10. The hybrid positive electrode material of claim 1, wherein the second positive electrode active powder includes a component selected from the group consisting of nickel cobalt manganese ternary material (NCM), nickel cobalt aluminum ternary material (NCA), nickel cobalt manganese aluminum quaternary material (NCMA), and combinations thereof.

11. The hybrid positive electrode material of claim 1, wherein the second positive electrode active powder is composed of a perovskite material and the first positive electrode active powder is composed of a high power lithium manganate or and electrochemically active material including nickel in an amount greater than 60 weight percent of the total weight of the second positive electrode active powder.

12. A positive electrode for a rechargeable lithium-ion battery comprising;
a current collector; and
an electrochemically active layer disposed over the current collector, the electrochemically active layer comprising a hybrid positive electrode active material comprising:
a first positive electrode active powder; and
a second positive electrode active powder, each particle of the second positive electrode active powder contacts a plurality of particles of the first positive electrode active powder, wherein an average particle size of the first positive electrode active powder is smaller than an average particle size of the second positive electrode active powder.

13. The positive electrode of claim 12, wherein the average particle size of the first positive electrode active powder has an average particle size from about 10 nm to about 1 micron and the average particle size of the second positive electrode active powder has an average particle size from about 1 to 20 microns.

14. The positive electrode of claim 12, wherein each particle of the second positive electrode active powder supports the plurality of particles of the first positive electrode active powder.

15. The positive electrode of claim 14, wherein each particle of the second positive electrode active powder has a sufficient pore size to allow the particles of the first positive electrode active powder to embed therein upon swelling of the particles in the second positive electrode active powder.

16. A rechargeable lithium-ion battery comprising at least one lithium-ion battery cell, each lithium-ion battery cell including:
a positive electrode comprising:
a current collector; and
an electrochemically active layer disposed over the current collector, the electrochemically active layer comprising a hybrid positive electrode active material comprising:
a first positive electrode active powder; and
a second positive electrode active powder, each particle of the second positive electrode active powder contacts a plurality of particles of the first positive electrode active powder, wherein an average particle size of the first positive electrode active powder is smaller than an average particle size of the second positive electrode active powder;
a negative electrode including a negative active material; and
an electrolyte contacting the positive electrode and the negative electrode.

17. The rechargeable lithium-ion battery of claim 16, wherein the average particle size of the first positive electrode active powder has an average particle size from about 10 nm to about 1 micron and the average particle size of the second positive electrode active powder has an average particle size from about 1 to 20 microns.

18. The rechargeable lithium-ion battery of claim 16, wherein each particle of the second positive electrode active powder supports the plurality of particles of the first positive electrode active powder.

19. The rechargeable lithium-ion battery of claim 18, wherein each particle of the second positive electrode active powder has a sufficient pore size to allow the particles of the first positive electrode active powder to embed therein upon swelling of the particles in the second positive electrode active powder.

20. The rechargeable lithium-ion battery of claim 19, wherein the positive electrode and/or the negative electrode includes at least one layer of perovskite-supported material.
